(19) United States
(12) Patent Application Publication
(10) Pub. No.: US 2024/0420107 A1
(43) Pub. Date: Dec. 19, 2024

(54) CHECKOUT MACHINE AND METHOD FOR CHECKOUT MACHINE

(71) Applicant: Toshiba Tec Kabushiki Kaisha, Tokyo (JP)

(72) Inventor: Yasunobu SUZUKI, Nagoya Aichi (JP)

(21) Appl. No.: 18/595,228

(22) Filed: Mar. 4, 2024

(30) Foreign Application Priority Data
Jun. 16, 2023 (JP) 2023-099416

(51) Int. Cl. G06Q 20/20

(52) U.S. Cl. CPC G06Q 20/20

(57) ABSTRACT

A checkout machine installed in a store includes an input device, a memory that stores discount information indicating payment methods acceptable to the store and whether a discount is to be applied to a settlement amount when each of the payment methods is used, and a processor to acquire a settlement amount for a transaction in the store. Upon selection of one of the payment methods via the input device, the processor determines whether a discount is to be applied to the settlement amount based on the discount information. When a discount is to be applied to the settlement amount, the processor applies the discount to the settlement amount and executes settlement processing for completing the transaction using the selected payment method.

### CROSS-REFERENCE TO RELATED APPLICATION

This application is based upon and claims the benefit of priority from Japanese Patent Application No. 2023-099416, filed Jun. 16, 2023, the entire contents of which are incorporated herein by reference.

### FIELD

Embodiments described herein relate generally to a checkout machine, a method for a checkout machine, and a non-transitory computer readable medium storing program instructions for a checkout machine.

### BACKGROUND

There are two different types of electronic money, one of which is usable only in the stores operated by a particular company and its group companies and is called “house electronic money,” and the other is common electronic money usable more widely. So called common electronic money may be such things such as transportation system electronic money, specialized distributor electronic money, and credit card electronic money. The house electronic money can motivate customers to solely use the stores operated by a particular company. Since expansion of use of the house electronic money generally leads to profits of the company (“the house”), an increasing number of stores are attempting to increase use of house electronic money by discounting a settlement amount if the transaction is settled using house electronic money.

In the stores that accept house electric money, as explained above, a store clerk at a checkout counter checks if a customer wants to use the house electric money, and if so, the store clerk has to perform a particular operation on a checkout machine to apply a discount, and then perform another operation for the settlement using the house electric money.

### BRIEF DESCRIPTION OF THE DRAWINGS

FIG. 1 is a hardware block diagram of a checkout machine.

FIG. 2 is a schematic diagram illustrating a configuration of a discount table.

FIG. 3 is a flowchart of information processing executed by the checkout machine.

FIG. 4 is a flowchart of the information processing;

FIG. 5 is a flowchart of the information processing;

FIG. 6 is a flowchart of the information processing;

FIG. 7 is a schematic diagram illustrating a display example of a subtotal screen.

FIG. 8 is a schematic diagram illustrating a display example of a payment method selection screen.

FIG. 9 is a schematic diagram illustrating a display example of a discounted payment screen.

FIG. 10 is a schematic diagram illustrating a display example of a normal payment screen.

FIG. 11 is a schematic diagram illustrating a display example of a balance shortage screen.

### DETAILED DESCRIPTION

Embodiments provide a checkout machine that can automatically discount and settle a settlement amount if a price is paid by a discount target payment method and thus provides a technological solution to reduce a burden on a store clerk at a store utilizing house-type electronic money or the like.

In general, according to one embodiment, a checkout machine for a store or the like comprises an input device, a memory that stores discount information indicating one or more payment methods acceptable by the store and whether a discount is applied to a settlement amount when each of the payment methods is used, and a processor configured to: acquire a settlement amount of a transaction in the store, upon selection of one of the payment methods via the input device, determine whether a discount is to be applied to the settlement amount based on the discount information, upon determining that a discount is to be applied to the settlement amount, apply the discount to the settlement amount, and execute settlement processing for completing the transaction using the selected payment method to pay the settlement amount after the discount has been applied.

Embodiments for such a checkout machine and a method performed thereby are explained below with reference to the drawings.

For example, the checkout machine is a full-service-type checkout machine or a point-of-sale (POS) terminal with which a store clerk performs operation relating to commodity registration and operation relating to settlement, a self-service-type checkout machine with which a customer performs operation relating to commodity registration and operation relating to settlement, a semi-self-service-type checkout machine with which a store clerk performs operation relating to commodity registration and a customer performs operation relating to settlement. Embodiments can be applied to the checkout machines of all types. Hereinafter, the full-service-type checkout machine is described for illustration purposes. A discount target payment method is electronic money.

[Explanation of a configuration of the checkout machine]

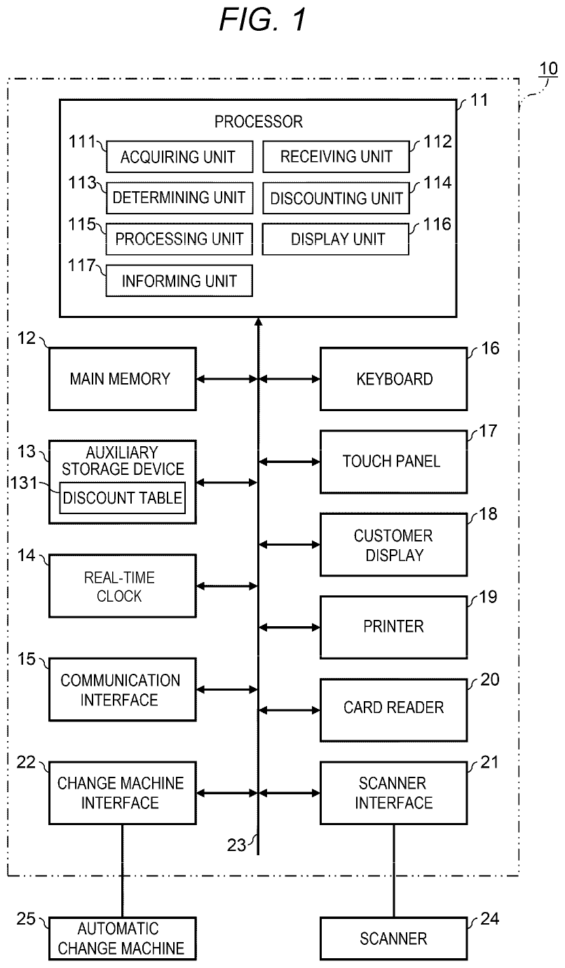

FIG. 1 is a hardware block diagram of a checkout machine 10 according to one embodiment. The checkout machine 10 includes a processor 11, a main memory 12, an auxiliary storage device 13, a real-time clock 14, a communication interface 15, a keyboard 16, a touch panel 17, a customer display 18, a printer 19, a card reader 20, a scanner interface 21, a change machine interface 22, a system transmission line 23, and the like. The system transmission line 23 includes an address bus, a data bus, a control signal line, and the like. The system transmission line 23 connects the processor 11 and the other units and transmits data signals exchanged between the processor 11 and the other units.

In the checkout machine 10, the processor 11, the main memory 12, the auxiliary storage device 13, the real-time clock 14, and the communication interface 15 are connected by the system transmission line 23 to configure a controller. Input and output devices such as the keyboard 16, the touch panel 17, the customer display 18, the printer 19, and the card reader 20 and device interfaces such as the scanner interface 21 and the change machine interface 22 are connected to the system transmission line 23 and controlled by the controller to implement the functions of the checkout machine 10. The input and output devices or the device interfaces connected to the system transmission line 23 are not limited to those described above.

The processor 11 controls each component of the checkout machine 10 in order to perform various functions thereof according to an operating system or application programs. The processor 11 is, for example, a CPU (Central Processing Unit).

The main memory 12 includes a nonvolatile memory region and a volatile memory region. The nonvolatile memory region of the main memory 12 stores the operating system or the application programs. The nonvolatile or volatile memory region of the main memory 12 stores data necessary for the processor 11 in executing processing for controlling the units. The volatile memory region of the main memory 12 is used as a work area where data is rewritten as appropriate by the processor 11. The nonvolatile memory region is, for example, a ROM (Read Only Memory). The volatile memory region is, for example, a RAM (Random Access Memory).

For example, the auxiliary storage device 13 is an EEPROM (Electric Erasable Programmable Read-Only Memory), an HDD (Hard Disk Drive), an SSD (Solid State Drive), or the like. The auxiliary storage device 13 stores data used by the processor 11 in performing various kinds of processing, data created by the processing in the processor 11, and the like. The auxiliary storage device 13 can store the application programs described above.

The real-time clock 14 tracks a date and time. The processor 11 processes, as a present date and time, the date and the time tracked by the real-time clock 14.

The communication interface 15 is an interface circuit for performing data communication with a store server, a credit server, an electronic money server, and the like connected via a communication network. The store server is a server computer for managing registration processing for commodity sales data, settlement processing for a transaction, and the like performed by the checkout machine 10. The credit server is a server computer for performing credit card settlement. The electronic money server is a server computer for performing electronic money settlement.

The keyboard 16 is, for example, an input device with various keys necessary for registration of a purchased commodity and settlement of a transaction. The touch panel 17 functions as an output device for displaying, for example, a commodity name, a price, and a total amount of a registered purchased commodity to a store clerk, who is an operator of the checkout machine 10. The touch panel 17 also functions as an input device for detecting touch input by the store clerk. The customer display 18 is an output device for displaying, for example, a commodity name, a price, and a total amount of a registered purchased commodity to a customer who purchases a commodity. The printer 19 is an output device for printing data on receipt paper and dispensing a purchase receipt or the like. The card reader 20 is an input device for reading card data of an electronic money card, a point card, a credit card, or the like.

The scanner interface 21 is an interface circuit for performing data communication with a scanner 24. The scanner 24 is a device that scans and reads a code such as a barcode or a two-dimensional code. The scanner 24 may be a stationary scanner or a handheld scanner.

The change machine interface 22 is an interface circuit for performing data communication with an automatic change machine 25. The automatic change machine 25 includes a function of counting cash of bills or coins deposited from a depositing port and storing the cash in a storage for each of denominations and a function of dispensing cash equivalent to change from the storage to a dispensing port. Note that a cash drawer may be connected instead of the automatic change machine 25.

The checkout machine 10 having the configuration explained above has a discount table 131 in the auxiliary storage device 13 in order to automatically discount and settle a settlement amount if a price is paid by a discount target payment method. The checkout machine 10 is configured such that the processor 11 performs the functions of an acquiring unit 111, a receiving unit 112, a determining unit 113, a discounting unit 114, a processing unit 115, a display unit 116, and an informing unit 117. Note that the functions of the processor 11 are not limited to these functions.

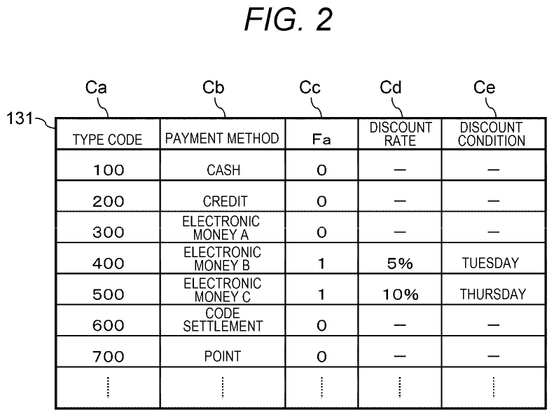

FIG. 2 is a schematic diagram illustrating a configuration of the discount table 131. As illustrated in FIG. 2, the discount table 131 has a type code column Ca, a payment method column Cb, a column Cc of a discount flag Fa, a discount rate column Cd, and a discount condition column Ce.

In the type code column Ca, unique type codes for payment method types are described. In the payment method column Cb, names of payment methods specified by the type codes described in the column Ca corresponding to the column Cb are described. As illustrated, in this example, a store where cash, a credit card, electronic money, code settlement, point payment, and the like can be used as payment methods is illustrated. As the electronic money, three types of “electronic money A”, “electronic money B”, and “electronic money C” can be used. The “electronic money A” is common electronic money such as transportation electronic money, distributor electronic money, or credit card electronic money. The “electronic money B” and the “electronic money C” are house electronic money usable only in stores operated by a company and its group companies. The “electronic money B” is house electronic money for general customers. The “electronic money C” is house electronic money for loyal customers.

In the column of the discount flag Fa, one-bit data for identifying whether the payment methods specified by the type codes described in the column Ca corresponding to the column are discount targets is described. In this example, the discount flag Fa indicating that a payment method is a discount target is represented as “1” and the discount flag Fa indicating that a payment method is not a discount target is represented as “0”. In the discount rate column Cd, discount rates are described if the payment methods specified by the type codes described in the column Ca corresponding to the column Cd are discount targets. In the discount condition column Ce, conditions for establishing discounts are described if the payment methods specified by the type codes described in the column Ca corresponding to the column Ce are discount targets. In this example, the conditions for applying discounts, that is, discount conditions are days of week.

In the discount table 131 illustrated in FIG. 2, a payment method “cash” and the discount flag Fa “0” are described in correlation with a type code “100”. A payment method “credit” and the discount flag Fa “0” are described in correlation with a type code “200”. A payment method “electronic money A” and the discount flag Fa “O” are described in correlation with a type code “300”. A payment method “electronic money B”, the discount flag Fa “1”, a discount rate “5%”, and a discount condition “Tuesday” are described in correlation with a type code “400”. A payment method “electronic money C”, the discount flag Fa “1”, a discount rate “10%”, and a discount condition “Thursday” are described in correlation with a type code “500”. A payment method “code settlement” and the discount flag Fa “0” are described in correlation with a type code “600”. A payment method “point” and the discount flag Fa “0” are described in correlation with a type code “700”. That is, the discount table 131indicates that only the “electronic money B” and the “electronic money C” are discount targets. The discount table 131 indicates that the discount rate of the “electronic money B” is 5% and the discount condition is satisfied if the discount condition is Tuesday. Similarly, the discount table 131 indicates that the discount rate of the “electronic money C” is 10% and the discount condition is satisfied if the discount condition is Thursday.

Referring back to FIG. 1, the acquiring unit 111 has a function of acquiring a settlement amount of a transaction. If the checkout machine 10 is installed and used in a retail store, a total amount of commodities purchased by a customer is the settlement amount of the transaction. If the checkout machine 10 is installed and used in a restaurant, a total amount of food and drink ordered by a customer is the settlement amount of the transaction. If the checkout machine 10 is installed and used in a store that provides services such as a movie theater or a sports gym, cost paid by a customer for the services is the settlement amount of the transaction.

The receiving unit 112 has a function of receiving selection input for a payment method for paying a settlement amount. The receiving unit 112 receives selection input for any one payment method out of various payment methods such as cash, a credit card, electronic money, code settlement, and point payment according to key input to the keyboard 16 or touch input to the touch panel 17.

The determining unit 113 has a function of determining whether a discount condition is satisfied if the payment method, the selection input for which was received by the receiving unit 112, is a discount target. For example, if the data illustrated in FIG. 2 is described in the discount table 131, discount target payment methods are the “electronic money B” and the “electronic money C”. A discount condition for the “electronic money B” is whether a transaction date is Tuesday. A discount condition for the “electronic money C” is whether a transaction date is Thursday. If payment is made by the “electronic money B” in a transaction on Tuesday or payment is made by the “electronic money C” in a transaction on Thursday, the determining unit 113 determines that the discount conditions are satisfied. The determining unit 113 determines that the discount conditions are not satisfied other than the conditions described above.

The discounting unit 114 has a function of discounting a settlement amount at a set discount rate if the payment method, the selection input for which was received by the receiving unit 112, is a discount target. Specifically, if the payment method, the selection input for which was received by the receiving unit 112, is a discount target and the determining unit 113 determined that a discount is applicable, the discounting unit 114 discounts the settlement amount at a discount rate set for the payment method in the discount table 131.

The processing unit 115 has a function of executing settlement processing for paying the settlement amount discounted by the discounting unit 114 with the payment method, the selection input for which was received by the receiving unit 112. For example, if a discount is applied because a payment method is the “electronic money B” in a transaction on Tuesday, the processing unit 115 executes electronic money settlement processing for deducting the settlement amount discounted by the discounting unit 114 from the balance of the “electronic money B”. For example, if a discount is applied because a payment method is the “electronic money C” in a transaction on Thursday, the processing unit 115 executes electronic money settlement processing for deducting the settlement amount discounted by the discounting unit 114 from the balance of the “electronic money C”.

The display unit 116 has a function of displaying the settlement amount after the discount on a display device, e.g., the touch panel 17 and/or the customer display 18, if the settlement amount is discounted by the discounting unit 114. The display unit 116 also has a function of displaying the settlement amount acquired by the acquiring unit 111 until selection input for a payment method is received by the receiving unit 112. That is, the display unit 116 controls the display device to display the settlement amount before the discount acquired by the acquiring unit 111 until selection input for a payment method is received by the receiving unit 112 and display the settlement amount after the discount on the display device if the settlement amount was discounted by the discounting unit 114. The display device may be either or both of the touch panel 171 and the customer display 172.

The informing unit 117 has a function of informing a shortage for the settlement amount before the discount if a payment amount in the discount target payment method, selection input for which was received by the receiving unit 112, is short for the settlement amount discounted by the discounting unit 114. The shortage is informed by display on the touch panel 171. The shortage may be informed by voice output or the like.

The functions of the receiving unit 112, the determining unit 113, the discounting unit 114, the processing unit 115, the display unit 116, and the informing unit 117 explained above are implemented by information processing executed by the processor 11 according to a checkout program. The checkout program is one of the application programs stored in the main memory 12 or the auxiliary storage device 13. A method of installing the checkout program in the main memory 12 or the auxiliary storage device 13 is not particularly limited. The checkout program can be copied and installed in the main memory 12 or the auxiliary storage device 13 from a non-transitory computer-readable storage medium or a remote computer via a communication network. The form of the storage medium does not matter if the recording medium can store a program and can be read by a computer like a CD-ROM, a memory card, or the like.

[Explanation of an operation of the checkout machine]

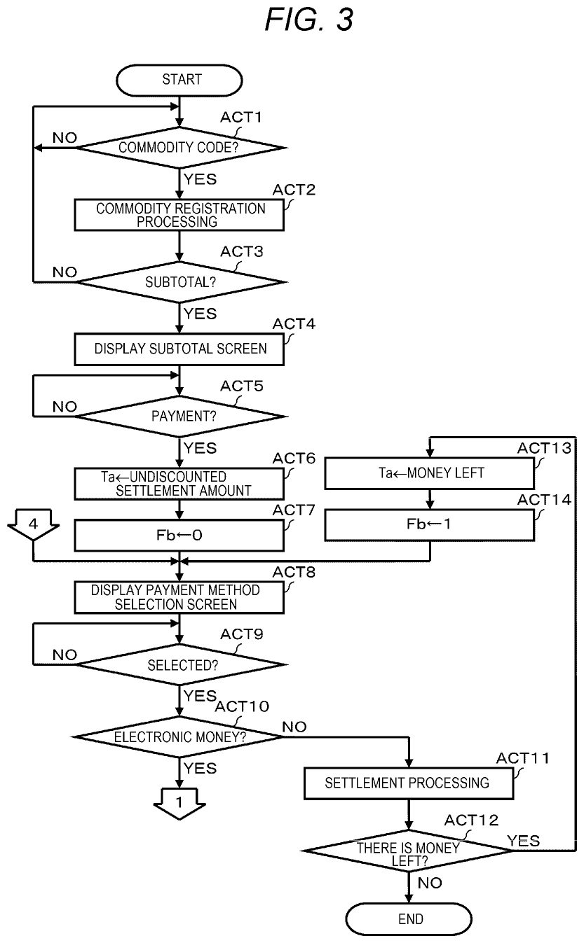

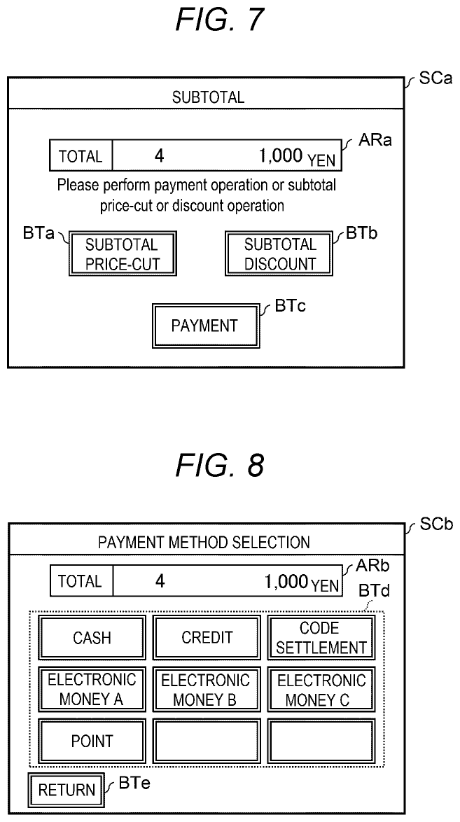

FIGS. 3 to 6 are flowcharts of information processing executed by the processor 11 of the checkout machine 10 according to the checkout program. FIGS. 7 to 11 are schematic diagrams illustrating various screen examples displayed on the touch panel 17 of the checkout machine 10. A main operation of the checkout machine 10 is explained with reference to the flowcharts of FIGS. 3 to 6 and the screen examples of FIGS. 7 to 11. Note that it is assumed that the checkout machine 10 is installed in a retail store.

The information processing explained below is merely an example. The information processing can be changed as appropriate if similar effects can be achieved. The screen examples are also examples. The text to be output, arrangement of images, types and a layout of software keys, and the like can be changed as appropriate.

If a customer requests settlement of a transaction, a store clerk who operates the checkout machine 10 inputs, one by one, commodity codes of commodities to be purchased by the customer to the checkout machine 10. Specifically, for a commodity attached with a barcode, the store clerk scans the barcode with the scanner 24 to thereby input the commodity code. For a commodity not attached with a barcode such as perishables, the store clerk selects the corresponding commodity on a list screen of barcode-less commodities displayed on the touch panel 17 to thereby input the commodity code. The store clerk is also capable of inputting a commodity code with key operation of the keyboard 16. If the store clerk has finished inputting the commodity codes of all the commodities to be purchased, the store clerk presses the subtotal key. The subtotal key may be a hard key disposed on the keyboard 16 or may be a soft key displayed on the touch panel 17.

In ACT 1, the processor 11 waits for a commodity code to be input. If a commodity code is input via the scanner 24, the touch panel 17, or the keyboard 16, the processor 11 proceeds to ACT 2. In ACT 2, the processor 11 executes commodity registration processing. That is, the processor 11 acquires the price of the commodity identified by the commodity code, generates commodity sales data including the commodity code, the price, the number of sold items, and the sales amount, and registers the commodity sales data in a transaction memory. The transaction memory is a part of the volatile memory region in the main memory 12.

The processor 11 that executed the commodity registration processing proceeds to ACT 3. In ACT 3, the processor 11 checks whether the subtotal key was operated. If the subtotal key was not operated (NO in ACT 3) and a new commodity code of the next commodity is input (Yes in ACT 1), the processor 11 proceeds to ACT 2. That is, the processor 11 executes the commodity registration processing, again. In this way, every time a commodity code of a commodity to be purchased by the customer is input, commodity sales data relating to the commodity is sequentially registered in the transaction memory.

If the subtotal key is operated in ACT 3, the processor 11 proceeds to ACT 4. In ACT 4, the processor 11 causes the touch panel 17 to display a subtotal screen SCa (see FIG. 7).

FIG. 7 is a display example of the subtotal screen SCa. As illustrated in FIG. 7, a total area ARa is arranged on the subtotal screen SCa. Soft keys such as a subtotal price-cut key BTa, a subtotal discount key BTb, and a payment key TBc are arranged on the subtotal screen SCa. A total number of items and a total amount are displayed in the total area ARa. The total number of items is obtained by totaling the numbers of purchased items indicated by the commodity sales data registered in the transaction memory. The total amount is obtained by totaling the sales amounts indicated by the commodity sales data registered in the transaction memory. The subtotal price-cut key BTa is a button for applying a price-cut to the total amount. The total discount key BTb is a button for applying a discount to the total amount. The payment key BTc is a button for processing payment for the total amount.

In ACT 4, the processor 11 controls the customer display 18 to display a subtotal screen on which the total number of items and the total amount are displayed. The processor 11 that controlled the display of the subtotal screen proceeds to ACT 5. In ACT 5, the processor 11 waits for the payment key BTc to be operated. Note that, although not illustrated, if the subtotal price-cut key BTa is operated in the waiting state in ACT 5, the processor 11 executes subtotal price-cut processing. That is, the processor 11 subtracts a price-cut amount input via the keyboard 16 from the total amount and updates the subtotal screen SCa such that the total amount after the price-cut is displayed in the total area ARa. If the subtotal discount key BTb is operated, the processor 11 executes subtotal discount processing. That is, the processor 11 discounts the total amount at a discount rate input via the keyboard 16 and updates the subtotal screen SCa such that the total amount after the discount is displayed in the total area ARa. The processor 11 that executed the subtotal price-cut processing or the subtotal discount processing waits for the payment key BTc to be operated.

If the payment key BTc is operated in ACT 5, the processor 11 proceeds to ACT 6. The processor 11 writes an undiscounted settlement amount into a work area Ta. If the subtotal price-cut processing or the subtotal discount processing has not been executed, the undiscounted settlement amount is obtained by totaling the sales amounts indicated by the commodity sales data registered in the transaction memory, that is, the total amount. If the subtotal price-cut processing or the subtotal discount processing has been executed, the undiscounted settlement amount is the total amount after the price-cut or the discount.

The processor 11 that has written the undiscounted settlement amount into the work area Ta proceeds to ACT 7. In ACT 7, the processor 11 sets a combination flag Fb to “0”. The combination flag Fb is one-bit data for identifying whether to combine two or more types of payment methods to pay a settlement amount. In this example, the combination flag Fb in combining the two or more types of payment methods to pay the settlement amount is represented as “1” and the combination flag Fb in paying the settlement amount with a single payment method is represented as “0”.In ACT 7, since it is not decided yet whether to pay the settlement amount with the single payment method or combine the two or more types of payment methods to pay the settlement amount, the processor 11 sets the combination flag Fb to “0”.

The processor 11 that has set the combination flag Fb to “0” proceeds to ACT 8. In ACT 8, the processor 11 controls the touch panel 17 to display a payment method selection screen SCb (see FIG. 8). Note that the subtotal screen on the customer display 18 does not transition to the payment method selection screen SCb.

FIG. 8 is a display example of the payment method selection screen SCb. As illustrated in FIG. 8, a total area ARb is arranged on the payment method selection screen SCb. Soft keys such as a payment method selection key BTd and a return key BTe are arranged on the payment method selection screen SCb. A total number of items and an unsettled total amount are displayed in the total area ARb. The payment method selection key BTd includes a plurality of soft keys to which the payment methods such as the cash, the credit card, the electronic money A, the electronic money B, the electronic money C, the code settlement, and the point payment are respectively allocated. The payment method selection key BTd is a button for receiving selection input for a payment method allocated to any one of the soft keys. The return key BTe is a button to return to the subtotal screen SCa.

The processor 11 that has controlled the display of the payment method selection screen SCb proceeds to ACT 9. In ACT 9, the processor 11 waits for a payment method to be selected. Note that, although not illustrated, if the return key BTe is operated in the waiting state in ACT 9, the processor 11 returns to ACT 4 and restores the screen of the touch panel 17 to the subtotal screen SCa.

If the payment method selection key BTd is operated in ACT 9, the processor 11 proceeds to ACT 10. In ACT 10, the processor 11 checks whether the electronic money is selected as the payment method. If a payment method other than the electronic money is selected, the processor 11 proceeds to ACT 11. In ACT 11, the processor 11 executes settlement processing corresponding to the payment method. For example, if the cash is selected, the processor 11 executes cash settlement processing for deducting the undiscounted settlement amount from the deposit amount deposited to the automatic change machine 25. For example, if the credit card is selected, the processor 11 executes credit settlement processing for deducting the undiscounted settlement amount from the account specified by the credit card. For example, if the code settlement is selected, the processor 11 executes code settlement processing for deducting the undiscounted settlement amount from the balance specified by the code for settlement read by the scanner 24. For example, if the point payment is selected, the processor 11 executes point settlement processing for deducting the point equivalent to the undiscounted settlement amount from the point owned by the customer. Note that, since the cash settlement processing, the credit settlement processing, the code settlement processing, and the point settlement processing are the well-known processing, detailed explanation of the processing is omitted here.

The processor 11 that has ended the settlement processing in ACT 11 proceeds to ACT 12. In ACT 12, the processor 11 checks whether there is any amount due in the undiscounted settlement amount. If there is no amount due, since the transaction has been settled, the processor 11 ends the information processing according to the checkout program.

If there is any amount due, since the transaction has not been settled yet, the processor 11 proceeds to ACT 13. In ACT 13, the processor 11 updates the amount in the work area Ta to the amount due. In ACT 14, the processor 11 sets the combination flag Fb to “1”. The processor 11 returns to ACT 8. That is, the processor 11 controls the touch panel 17 to display the payment method selection screen SCb. The processor 11 executes the processing in ACT 8 and subsequent acts in the same manner as explained above. Therefore, for example, if a payment method other than the electronic money is selected, the processor 11 executes settlement processing for paying the amount due with the payment method. Then, if confirming that the undiscounted settlement amount is paid in full, the processor 11 ends the information processing conforming to the checkout processing.

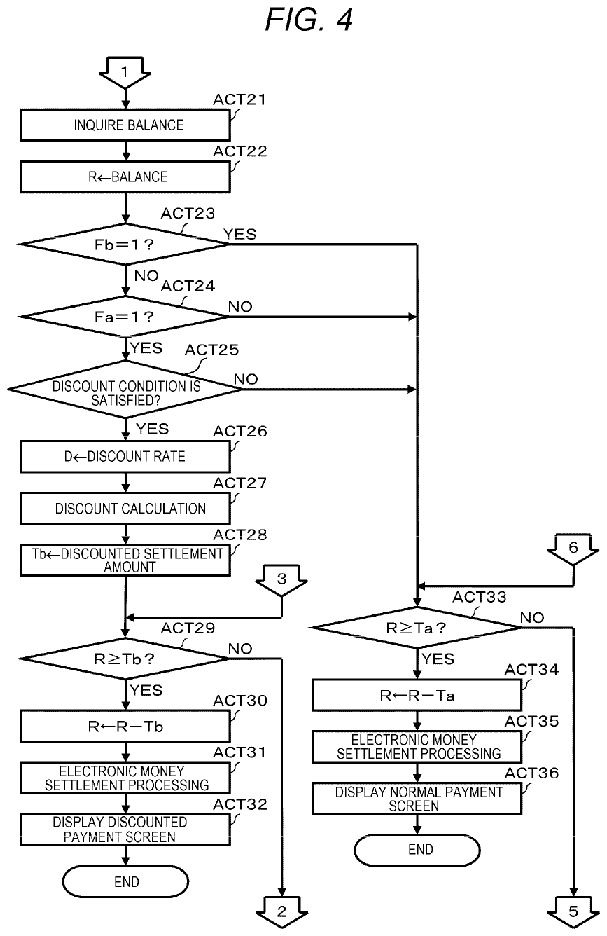

On the other hand, if the electronic money is selected as the price payment method in ACT 10, the processor 11 proceeds to ACT 21 in FIG. 4. In ACT 21, the processor 11 executes balance inquiry processing. That is, the processor 11 inquires the electronic money server about the balance using an electronic money ID read by the card reader 20 or the scanner 24.

The electronic money ID is an identifier of electronic money owed by the customer who selected the electronic money as the price payment method. For example, the customer carries an electronic money card in which the electronic money ID is recorded. Alternatively, the customer carries a smartphone installed with application software capable of displaying a barcode or a two-dimensional code indicating the electronic money ID. If the customer presents the electronic money card, the store clerk causes the card reader 20 to read data of the electronic money card. If the customer presented the smartphone, the store clerk causes the scanner 24 to read a barcode or a two-dimensional code displayed on a screen of the smartphone. Since the electronic money ID of the electronic money owned by the customer is input in this way, the processor 11 controls the communication interface 15 to send an inquiry about the balance. If acquiring the balance of the electronic money from the electronic money server in response to the inquiry, the processor 11 proceeds to ACT 22. In ACT 22, the processor 11 writes the balance of the electronic money into a work area R.

The processor 11 that has written the balance of the electronic money into the work area R proceeds to ACT 23. In ACT 23, the processor 11 checks the combination flag Fb. If the combination flag Fb is “1”, that is, if the electronic money payment is selected for the amount due after the payment by the payment method other than the electronic money, the processor 11 proceeds to ACT 33. Processing in ACT 33 and subsequent acts is explained later.

In contrast, if the combination flag Fb is “0”, that is, if the electronic money payment is selected for the undiscounted settlement amount, the processor 11 proceeds to ACT 24. In ACT 24, the processor 11 checks the discount flag Fa stored in the discount table 131 in correlation with a type code of the electronic money selected as the payment method.

If the discount flag Fa is “0”, that is, if payment by electronic money that is not a discount target is declared, the processor 11 proceeds to ACT 33. Processing in ACT 33 and subsequent acts is explained later.

In contrast, if the discount flag Fa is “1”, that is, if payment by the discount target electronic money is declared, the processor 11 proceeds to ACT 25. In ACT 25, the processor 11 determines whether a discount condition is satisfied. Specifically, the processor 11 acquires the discount condition described in the discount table 131 in correlation with the type code of the electronic money selected as the payment method. The processor 11 checks whether a day of week of the discount condition coincides with a day of week of a date tracked by the real-time clock 14. If the days of week coincide, the processor 11 determines that the discount condition is satisfied. If the days of week do not coincide, the processor 11 determines that the discount condition is not satisfied. If the discount condition is not satisfied, the processor 11 proceeds to ACT 33. Processing in ACT 33 and subsequent acts is explained later.

In contrast, if the discount condition is satisfied, the processor 11 proceeds to ACT 26. In ACT 26, the processor 11 writes the discount rate into a work area D. That is, the processor 11 acquires the discount rate described in the discount table 131 in correlation with the type code of the electronic money selected as the payment method and writes the discount rate into the work area D. In ACT 27, the processor 11 performs discount calculation. That is, the processor 11 discounts the undiscounted settlement amount stored in the work area Ta at the discount rate stored in the work area D. In ACT 28, the processor 11 writes the settlement amount after the discount, that is, the discounted settlement amount into a work area Tb.

The processor 11 that has written the discounted settlement amount into the work area Tb proceeds to ACT 29. In ACT 29, the processor 11 checks whether the balance stored in the work area R is equal to or more than the discounted settlement amount stored in the work area Tb. If the balance is equal to or more than the discounted settlement amount, the discounted settlement amount can be paid in full by the electronic money selected as the payment method. However, if the balance is less than the discounted settlement amount, the discounted settlement amount cannot be paid in full by the electronic money.

If the balance is equal to or more than the discounted settlement amount in ACT 29 and the payment is completed only by the electronic money of the type selected as the payment method, the processor 11 proceeds to ACT 30. In ACT 30, the processor 11 deducts the settlement amount after the discount stored in the work area Tb from the balance of the electronic money stored in work area R to update the balance in the work area R to the balance after the payment. In ACT 31, the processor 11 executes electronic money settlement processing. That is, the processor 11 performs processing for updating the balance of the electronic money managed by the electronic money ID in the electronic money server to the balance after the payment. Since the electronic money settlement processing is the well-known processing, detailed explanation of the electronic money settlement processing is omitted here.

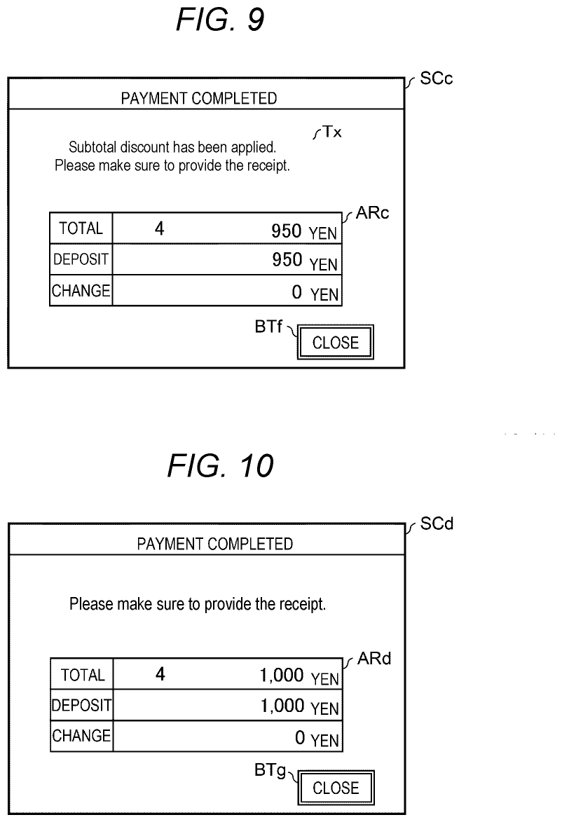

The processor 11 that ended the electronic money settlement processing in ACT 31 proceeds to ACT 32. In ACT 32, the processor 11 controls the touch panel 17 to display a discounted payment screen SCc (see FIG. 9).

FIG. 9 is a display example of the discounted payment screen SCc. A settlement information area ARc is arranged on the discounted payment screen SCc. A close button BTfis arranged on the discounted payment screen SCc. Text Tx indicating that a subtotal discount has been applied is displayed on the discounted payment screen SCc. The settlement information area ARc is divided into a “total” area, a “deposit” area, and a “change” area. The total number of items and the discounted settlement amount are displayed in the “total” area. The discounted settlement amount is displayed in the “deposit” area. 0 yen is displayed in the “change” area. The close button BTf is a button to close the discounted payment screen SCc. The store clerk who checked the discounted payment screen SCc operates the close button BTf.

In ACT 32, the processor 11 also controls the customer display 18 to display a discounted payment screen on which the information of the settlement information area ARc and the text Tx indicating that the subtotal discount has been applied are displayed. The processor 11 that controlled the display of the discounted payment screen ends the information processing conforming to the checkout program.

If the combination flag Fb is “1” in ACT 23, if the discount flag Fa is “0” in ACT 24, or if the discount condition is not satisfied in ACT 25 as explained above, the processor 11 proceeds to ACT 33. In ACT 33, the processor 11 checks whether the balance stored in the work area R is equal to or more than the undiscounted settlement amount or the amount due stored in the work area Ta. If the balance is equal to or more than the undiscounted settlement amount or the amount due, the undiscounted settlement amount or the amount due can be paid in full by the electronic money selected as the payment method. However, if the balance is less than the undiscounted settlement amount or the amount due, the undiscounted settlement amount or the amount due cannot be paid in full by the electronic money.

If the balance is equal to or more than the undiscounted settlement amount or the amount due in ACT 33 and the payment is completed only by the electronic money, the processor 11 proceeds to ACT 34. In ACT 34, the processor 11 deducts the undiscounted settlement amount or the amount due stored in the work area Ta from the balance of the electronic money stored in the work area R to update the balance in the work area R to the balance after the payment. In ACT 35, the processor 11 executes electronic money settlement processing. If ending the electronic money settlement processing, the processor 11 proceeds to ACT 36. In ACT 36, the processor 11 controls the touch panel 17 to display a normal payment screen SCd (see FIG. 10).

FIG. 10 is a display example of the normal payment screen SCd. A settlement information area ARd is arranged on the normal payment screen SCd. A close button BTg is arranged on the normal payment screen SCd. The text Tx indicating that the subtotal discount has been applied is not displayed on the normal payment screen SCd. The settlement information area ARd is divided into a “total” area, a “deposit” area, and a “change” area. The total number of items and the undiscounted settlement amount are displayed in the “total” area. The undiscounted settlement amount is displayed in the “deposit” area. “0 yen” is displayed in the “change” area. The close button BTf is a button for declaring to close the normal payment screen SCd. The store clerk who checked the normal payment screen SCd operates the close button BTf.

In ACT 32, the processor 11 controls the customer display 18 to display a normal payment screen on which the information of the settlement information area ARd is displayed. The processor 11 that controlled the display of the normal payment screen ends the information processing conforming to the checkout program.

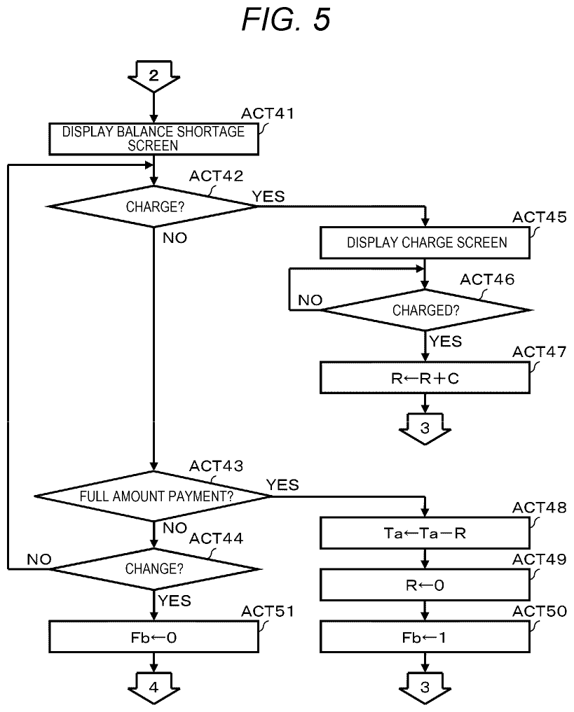

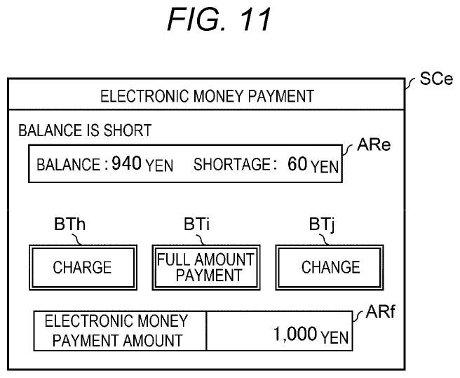

If the balance is less than the discounted settlement amount in ACT 29 and the payment is not completed only by the electronic money of the type selected as the payment method, the processor 11 proceeds to ACT 41 in FIG. 5. In ACT 41, the processor 11 controls the touch panel 17 to display a balance shortage screen SCe (see FIG. 11).

FIG. 11 is a display example of the balance shortage screen SCe. A balance shortage area ARe and a payment amount area ARf are arranged on the balance shortage screen SCe. Soft keys such as a charge key BTh, a full amount payment key BTi, and a change key BTj are arranged on the balance shortage screen SCe. The balance and the shortage of the electronic money stored in the work area R are displayed in the balance shortage area ARe. The shortage is an amount obtained by subtracting the balance of the electronic money from the undiscounted settlement amount stored in the work area Ta. The shortage is not an amount obtained by subtracting the balance of the electronic money from the discounted settlement amount stored in the work area Tb. The undiscounted settlement amount stored in the work area Ta is displayed in the payment amount area ARf. The charge key BTh is a button to add funds to the electronic money account. The full amount payment key BTi is a button to pay a part of the undiscounted settlement amount with the balance of the electronic money. The change key BTj is a key to change the payment method to a payment method other than the electronic money of the type selected as the payment method.

If the customer having balance shortage desires charge the electronic money, the store clerk operates the charge key BTh. Then, since the screen of the touch panel 17 changes to a charge screen, the store clerk designates a charge amount equal to or more than the shortage and deposits cash equivalent to the charge amount to the automatic change machine 25.

If the customer having the balance shortage desires to pay a part of the undiscounted settlement amount with the balance, the store clerk operates the full amount payment key BTi. If the customer requests to change the payment method, the store clerk operates the change key BTj.

The processor 11 that controlled the display of the balance shortage screen SCe proceeds to ACT 42. In ACT 42, the processor 11 checks whether the charge key BTh is operated. If the charge key BTh is not touched, the processor 11 proceeds to ACT 43. In ACT 43, the processor 11 checks whether the full amount payment key BTi is operated. If the full amount payment key BTi is not operated, the processor 11 proceeds to ACT 44. In ACT 44, the processor 11 checks whether the change key BTj is operated. If the change key BTj is not operated, the processor 11 returns to ACT 42. In this way, in ACT 42 to ACT 44, the processor 11 waits for the charge key BTh, the full amount payment key BTi, or the change key BTj to be operated.

If the charge key BTh is operated in the waiting state in ACT 42 to ACT 44, the processor 11 proceeds to ACT 45. In ACT 45, the processor 11 controls the touch panel 17 to display a charge screen. The charge screen is a screen for receiving input of an amount (“charge amount”) of funds to be added to the account. The processor 11 that controlled the display of the charge screen proceeds to ACT 46. In ACT 46, the processor 11 waits for charge. That is, the processor 11 waits for cash equivalent to a charge amount C received on the charge screen to be deposited to the automatic change machine 25. If the cash equivalent to the charge amount C is deposited to the automatic change machine 25, the processor 11 proceeds to ACT 47. In ACT 47, the processor 11 updates the balance of the electronic money stored in the work area R to the amount obtained by charging the charge amount C.

Thereafter, the processor 11 returns to ACT 29. The processor 11 executes the processing in ACT 29 and subsequent acts in the same manner as explained above. If an amount equal to or more than the shortage is charged, since the payment is completed only by the electronic money of the type selected as the payment method, the processor 11 executes the processing in ACT 30 to ACT 32. That is, the electronic money settlement processing for the discounted settlement amount is executed.

If the full amount payment key BTi is operated in the waiting state in ACT 42 to ACT 44, the processor 11 proceeds to ACT 48. In ACT 48, the processor 11 updates the undiscounted settlement amount stored in the work area Ta to the amount reduced by the balance of the electronic money stored in the work area R. In ACT 49, the processor 11 sets the balance in the work area R to “0”. In ACT 50, the processor 11 sets the combination flag Fb to “1”. Thereafter, the processor 11 returns to ACT 29. Therefore, since the balance stored in the work area R is not equal to or more than the discounted settlement amount stored in the work area Tb, the processor 11 sets the balance in the balance shortage area ARe on the balance shortage screen SCe to “0” and, thereafter, returns to the waiting state in ACT 42 to ACT 44. Note that, at this time, the charge key BTh and the full amount payment key BTi are disabled. That is, the processor 11 accepts only an operation on the change key BTj.

If the change key BTj is touched in the waiting state in ACT 42 to ACT 44, the processor 11 proceeds to ACT 51. In ACT 51, the processor 11 sets the combination flag Fb to “0”. Thereafter, the processor 11 returns to ACT 8. That is, the processor 11 controls the touch panel 17 to display the payment method selection screen SCb. Thereafter, the processor 11 executes the processing in ACT 9 and subsequent acts in the same manner as explained above.

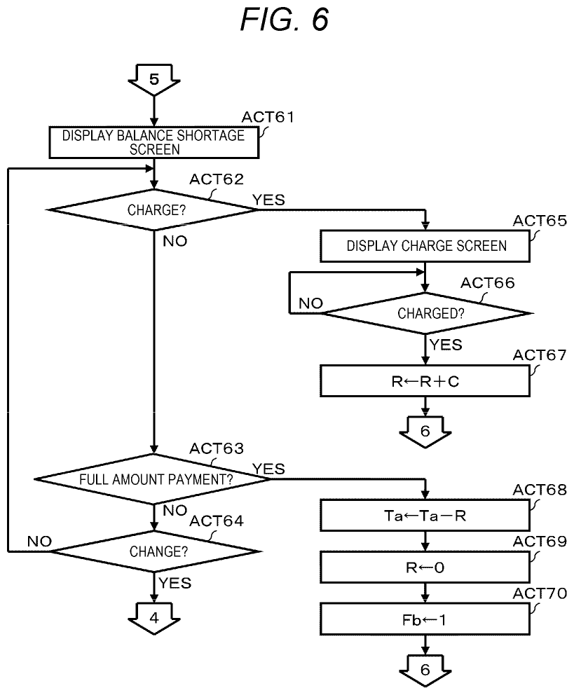

If the balance is less than the undiscounted settlement amount in ACT 33 and the payment is not completed only by the electronic money of the type selected as the payment method, the processor 11 proceeds to ACT 61 in FIG. 6. In ACT 61, the processor 11 controls the touch panel 17 to display the balance shortage screen SCe. On the balance shortage screen SCe as well, the balance of the electronic money and the shortage obtained by subtracting the balance of the electronic money from the undiscounted settlement amount are displayed in the balance shortage area ARe. The undiscounted settlement amount is displayed in the payment amount area ARf.

If the customer having the balance shortage desires to charge the electric money, the store clerk operates the charge key BTh and deposits cash equivalent to a charge amount to the automatic change machine 25. If the customer having the balance shortage desires to pay a part of the undiscounted settlement amount with the balance, the store clerk operates the full amount payment key BTi. If the customer requests changing the payment method, the store clerk operates the change key BTj.

In ACT 62, the processor 11 that controlled the display of the balance shortage screen SCe checks whether the charge key BTh is operated. If the charge key BTh is not operated, the processor 11 proceeds to ACT 63. In ACT 63, the processor 11 checks whether the full amount payment key BTi is operated. If the full amount payment key BTi is not operated, the processor 11 proceeds to ACT 64. In ACT 64, the processor 11 checks whether the change key BTj is operated. If the change key BTj is not operated, the processor 11 returns to ACT 62. In this way, in ACT 62 to ACT 64, the processor 11 waits for the charge key BTh, the full amount payment key BTi, or the change key BTj to be operated.

If the charge key BTh is operated in the waiting state in ACT 62 to ACT 64, the processor 11 proceeds to ACT 65. In ACT 65, the processor 11 controls the touch panel 17 to display a charge screen. In ACT 66, the processor 11 waits for a deposit. If cash equivalent to the charge amount C is deposited to the automatic change machine 25, the processor 11 proceeds to ACT 67. In ACT 67, the processor 11 updates the balance of the electronic money stored in the work area R to an amount obtained by charging the charge amount C.

Thereafter, the processor 11 returns to ACT 33. The processor 11 executes the processing in ACT 33 and subsequent acts in the same manner as explained above. Therefore, if an amount equal to or more than the shortage is charged, since the payment is completed only by the electronic money of the type selected as the payment method, the processor 11 executes the processing in ACT 34 to ACT 36. That is, the electronic money settlement processing for the undiscounted settlement amount is executed.

If the full amount payment key BTi is operated in the waiting state in ACT 62 to ACT 64, the processor 11 proceeds to ACT 68. In ACT 68, the processor 11 updates the undiscounted settlement amount stored in the work area Ta to an amount reduced by the balance of the electronic money stored in the work area R. In ACT 69, the processor 11 sets the balance in the work area R to “0”. In ACT 70, the processor 11 sets the combination flag Fb to “1”. Thereafter, the processor 11 returns to ACT 33. Therefore, since the balance stored in the work area R is not equal to or more than the undiscounted settlement amount stored in the work area Ta, the processor 11 sets the balance in the balance shortage area ARe on the balance shortage screen SCe to “0” and, thereafter, returns to the waiting state in ACT 62 to ACT 64. Note that, at this time, the charge key BTh and the full amount payment key BTi are disabled. That is, the processor 11 accepts only an operation on the change key BTj.

If the change key BTj is operated in the waiting state in ACT 62 to ACT 64, the processor 11 returns to ACT 8. That is, the processor 11 controls the touch panel 17 to display the payment method selection screen SCb. Thereafter, the processor 11 executes the processing in ACT 9 and subsequent acts in the same manner as explained above.

[Effects of the checkout machine]

The processor 11 that controls the operations explained above executes the function of the acquiring unit 111 with the processing in ACT 6. The processor 11 executes the function of the receiving unit 112 with the processing in ACT 8 and ACT 9. The processor 11 executes the function of the determining unit 113 with the processing in ACT 25. The processor 11 executes the function of the discounting unit 114 with the processing in ACT 26 to ACT 28. The processor 11 executes the function of the processing unit 115 with the processing in ACT 30 and ACT 31. The processor 11 executes the function of the display unit 116 with the processing in ACT 8 and ACT 32. The processor 11 executes the function of the informing unit 117 with the processing in ACT 41.

As a result, if the payment method, the selection input for which was received by the receiving unit 112, is the discount target payment method and the determining unit 113 determines that the discount condition is satisfied, in the checkout machine 10, the discounting unit 114 automatically performs, for the settlement amount of the transaction acquired by the acquiring unit 111, discount calculation at a predetermined discount rate. The processing unit 115 executes settlement processing for paying the discounted settlement amount with the payment method, the selection input for which was received by the receiving unit 112.

Therefore, the store clerk does not need to determine whether the payment method selected by the customer is a discount target and whether the discount condition is satisfied if the payment method is the discount target. The store clerk does not need to perform, on the checkout machine 10, operation for deducting the settlement amount if the discount is established. Accordingly, it is possible to provide the checkout machine 10 that can reduce a burden on the store clerk.

[Othe embodiments]

A full-service-type checkout machine is illustrated in the above embodiment. However, the embodiment can be applied to a self-service-type checkout machine and a semi-self-service-type checkout machine in the same manner. That is, by imparting the functions of the acquiring unit 111, the receiving unit 112, the determining unit 113, the discounting unit 114, the processing unit 115, the display unit 116, and the informing unit 117 to a processor, it is possible to obtain a checkout machine that can automatically discount and settle a settlement amount if a price is paid by a discount target payment method.

In the above embodiment, the discount target payment method is electronic money. However, the discount target payment method is not limited to electronic money. For example, code settlement can be set as a discount target payment method by setting the discount flag Fa corresponding to the type code “600” of the code settlement to “1”, for example, in the discount table 131.

The discount rate can be easily changed by changing the information of the column Cd of the discount table 131 as appropriate. Similarly, the discount condition can also be easily changed by changing the information in the column Ce of the discount table 131 as appropriate.

Incidentally, the discount condition is not limited to the day of week. For example, a threshold for a total amount of a transaction may be set as the discount condition. That is, if the total amount of the transaction to be paid by the discount target payment method is equal to or more than the threshold, the determining unit 113 may determine that the discount condition is satisfied. The discount condition may be a specific commodity. That is, if the specific commodity is included in purchased commodities of the transaction to be paid by the discount target payment method, the determining unit 113 may determine that the discount condition is satisfied.

Note that the determining unit 113 is not always an essential element. In the case of an operation for performing discount processing for all transactions to be paid by the discount target payment method, the determining unit 113 may be excluded. It goes without saying that a burden on the store clerk can be reduced for such an operation as well.

This operation can also be applied if the settlement amount is automatically price-cut rather than being automatically discounted. That is, the discounting unit 114 only has to be changed to a price-cutting unit that cuts a predetermined amount from the settlement amount.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A checkout machine for a retail store, comprising:
an input device;
a memory that stores discount information indicating one or more payment methods acceptable by the store and whether a discount is to be applied to a settlement amount when each of the payment methods is used; and
a processor configured to:
acquire a settlement amount of a transaction in the store,
upon selection of one of the payment methods via the input device, determine whether a discount is to be applied to the settlement amount based on the discount information,
upon determining that a discount is applied to the settlement amount, apply the discount to the settlement amount, and
execute settlement processing for completing the transaction using the selected payment method to pay the settlement amount to which the discount has been applied.

2. The checkout machine according to claim 1, wherein
the discount information further indicates a discount rate for each of the payment methods, and
the processor is configured to update the acquired settlement amount based on the discount rate corresponding to the selected payment method.

3. The checkout machine according to claim 1, further comprising:
a display, wherein
the processor is configured to control the display to display the settlement amount to which the discount has been applied.

4. The checkout machine according to claim 3, wherein the processor is configured to control the display to display the acquired settlement amount before the discount is applied thereto.

5. The checkout machine according to claim 3, further comprising:
a touch panel including the input device and the display.

6. The checkout machine according to claim 1, wherein the processor is configured to:
determine whether a balance of an account corresponding to the selected payment method is enough to pay the settlement amount after the discount has been applied, and
upon determining that that balance is not enough, issue a notification.

7. The checkout machine according to claim 6, further comprising:
a display on which the notification is displayed.

8. The checkout machine according to claim 7, wherein the processor is configured to control the display to display a screen through which funds can be added to the account.

9. The checkout machine according to claim 1, wherein
the discount information further indicates a discount condition for each of the payment methods, and
the processor is configured to determine to apply the discount to the settlement amount when the discount condition corresponding to the selected payment method is met.

10. The checkout machine according to claim 1, further comprising:
a scanner interface connectable to a scanner, wherein
the processor is configured to acquire the settlement amount based on one or more item codes that have been input via the scanner.

11. A method for a checkout machine installed in a store, the method comprising:
acquiring a settlement amount of a transaction in the store;
acquiring discount information indicating one or more payment methods acceptable by the store and whether a discount is applied to a settlement amount when each of the payment methods is used;
accepting a selection of one of the payment methods and determining whether a discount is to be applied to the settlement amount based on the discount information;
upon determining that a discount is to be applied to the settlement amount, applying the discount to the settlement amount; and
executing settlement processing for completing the transaction using the selected payment method to pay the settlement amount to which the discount has been applied.

12. The method according to claim 11, wherein
the discount information further indicates a discount rate for each of the payment methods, and
the method further comprises:
updating the acquired settlement amount based on the discount rate corresponding to the selected payment method.

13. The method according to claim 11, further comprising:
displaying the settlement amount to which the discount has been applied.

14. The method according to claim 13, further comprising:
displaying the acquired settlement amount before the discount is applied thereto.

15. The method according to claim 13, wherein the settlement amount is displayed on a touch panel through which one of the payment methods is selectable.

16. The method according to claim 11, further comprising:
determining whether a balance of an account corresponding to the selected payment method is enough to pay the settlement amount after the discount has been applied, and
upon determining that that balance is not enough, issuing a notification.

17. The method according to claim 16, wherein the notification is output on a display.

18. The method according to claim 17, further comprising:
displaying on the display a screen through which funds can be added to the account.

19. The method according to claim 11, wherein
the discount information further indicates a discount condition for each of the payment methods, and
the method further comprises:
determining to apply the discount to the settlement amount when the discount condition corresponding to the selected payment method is met.

20. A non-transitory computer readable medium storing program instructions which when executed causing a checkout machine to perform a method comprising:
acquiring a settlement amount of a transaction performed in a store;
acquiring discount information indicating one or more payment methods acceptable by the store and whether a discount is to be applied to a settlement amount when each of the payment methods is used;
accepting a selection of one of the payment methods, and determining whether a discount is to be applied to the settlement amount based on the discount information;
upon determining that a discount is to be applied to the settlement amount, applying the discount to the settlement amount; and
executing settlement processing for completing the transaction using the selected payment method to pay the settlement amount after the discount has been applied.
